(19) United States
(12) Patent Application Publication
(10) Pub. No.: US 2015/0301209 A1
(43) Pub. Date: Oct. 22, 2015

(54) Estimating A Wavefield For A Dip

(71) Applicant: WesternGeco L.L.C., Houston, TX (US)

(72) Inventors: Can Evren Yarman, Cambridge (GB); Garret Flagg, Houston, TX (US)

(21) Appl. No.: 14/691,751

(22) Filed: Apr. 21, 2015

Related U.S. Application Data
(60) Provisional application No. 61/982,624, filed on Apr. 22, 2014.

(51) Int. Cl. G01V 1/30; G01V 1/28

(52) U.S. Cl. CPC G01V 1/30; G01V 1/28; G01V 2210/56; G01V 2210/66

(57) ABSTRACT

At least one dip is determined using an estimator for the at least one dip based on measured multicomponent survey data. At least one wavefield for the at least one dip is estimated using a processing technique that employs matching pursuit.

### CROSS-REFERENCE TO RELATED APPLICATION

This application claims the benefit under 35 U.S.C. §119(e) of U.S. Provisional Application Ser. No. 61/982,624, entitled “ESTIMATING A WAVEFIELD FOR A DIP,” filed Apr. 22, 2014, which is hereby incorporated by reference.

### BACKGROUND

Survey data can be collected and processed to produce a representation (e.g. image) of a subsurface structure. In some implementations, survey data includes seismic survey data collected using seismic survey equipment. The seismic survey equipment includes one or more seismic sources that are activated to produce seismic wavefields propagated into the subsurface structure. A part of the seismic wavefields is reflected from the subsurface structure and detected by seismic receivers that are part of the survey equipment.

### SUMMARY

In general, according to some implementations, at least one dip is determined using an estimator for the at least one dip based on measured multicomponent survey data. At least one wavefield for the at least one dip is estimated using a processing technique that employs matching pursuit.

Other or additional features will become apparent from the following description, from the drawings and from the claims.

### BRIEF DESCRIPTION OF THE DRAWINGS

Some embodiments are described with respect to the following figures.

FIG. 1 is a flow diagram of a wavefield estimation process according to some implementations.

FIGS. 2 and 3 are schematic diagrams of an example marine survey arrangement for collecting survey data regarding a subsurface structure.

FIG. 4 is a flow diagram of an algorithm according to further implementations.

FIG. 5 is a block diagram of an example control system that includes a wavefield estimation module according to some implementations.

### DETAILED DESCRIPTION

In the ensuing discussion, reference is made to performing wavefield estimation according to some implementations in a marine survey environment. Note, however, that techniques or mechanisms according to some implementations can also be applied in land-based survey environments or wellbore-based survey environments in which survey data is measured by one or more survey receivers. In addition, techniques or mechanisms according to some implementations can be applied in other contexts, such as based on data collected by cables or streamers that are in slanted acquisition profiles (cables or streamers including survey receivers and/or survey sources are slanted rather than horizontal) and/or towed in turning configurations (e.g. data acquired by survey arrangements that shoot in turns or that perform coil-based acquisition).

Moreover, although reference is made to performing surveying to characterize a subsurface structure, techniques or mechanisms according to some implementations can also be applied to perform surveys of other structures, such as human tissue, a mechanical structure, plant tissue, animal tissue, a solid volume, a substantially solid volume, a liquid volume, a gas volume, a plasma volume, a volume of space near and/or outside the atmosphere of a planet, asteroid, comet, moon, or other body, and so forth. In addition, the following describes seismic sources and seismic receivers that are part of seismic survey equipment. In other implementations, other types of survey equipment can be used, which can include other types of survey sources and survey receivers.

Wavefield estimation is used for estimating wavefields (also referred to as wavelets) in a subsurface structure. A wavefield (or wavelet) refers to wave data that is produced in the subsurface structure in response to wavefields produced by at least one survey source, where the at least one survey source can include a vibrator, an air gun, or any other source capable of producing acoustic energy. Wavefield estimation can be used in performing decomposition, in which an upgoing wavelet and a downgoing wavelet are computed. The composition of measured survey data into upgoing and downgoing wavelets can be used to perform deghosting of the measured survey data.

Seismic surveying can be performed in a marine environment. An issue associated with marine seismic surveying is the presence of ghost data. Ghost data can refer to data in measurement data resulting from reflections from an air-water interface of the marine environment. A seismic wavefield generated by a seismic source is propagated generally downwardly into the subsurface structure. A reflected seismic wavefield (that is in response to the seismic wavefield propagated by the seismic source) propagates generally upwardly toward an arrangement of seismic receivers. In the marine environment, where receivers are generally positioned beneath the water surface (e.g. sea surface), the seismic wavefield reflected from the subsurface structure continues to propagate upward past the receivers towards the air-water interface, where the seismic wavefield is reflected back downwardly.

This reflected, generally downwardly traveling seismic wavefield from the air-water interface is detected by the seismic receivers as ghost data, which appears in measurement data collected by the seismic receivers. The presence of ghost data can result in reduced accuracy when generating a representation of the subsurface structure based on the measurement data.

Deghosting attempts to remove ghost data from measured survey data. Ghost data (or ghost reflections) can result in gaps or notches in the amplitude spectra of recorded survey data, where the notches can reduce the useful bandwidth of the survey data. Generally, deghosting is applied to the total wavefield (the sum of the upgoing and downgoing wavefields); the deghosting produces the upgoing portion (the portion reflected from a subsurface structure) of the total wavefield. In a deghosting procedure, a given component of the recorded total wavefield can be expressed mathematically as the combination of a ghost operator (which corresponds to the given component) and the upgoing wavefield.

Generally, an upgoing wavefield refers to a wavefield that travels in a direction that has at least one directional component that is in the vertical up direction. Similarly, a downgoing wavefield refers to a wavefield that travels in a direction that has at least one directional component that is in the vertical down direction.

Upgoing and downgoing wavefield decomposition can allow for the survey data to be processed for the purpose of developing an image of the subsurface structure and/or to build a model for the subsurface structure. In some examples, an image of a subsurface structure can be performed using migration performed based on the wavefield decomposition of the measured survey data. Migration can include beam-like migration or another type of migration. Beam-like migration can refer to decomposition of the seismic data into localized dipping components where each component is migrated towards the corresponding dip direction (also referred to as “dip slope”).

A dip can refer to a magnitude of an inclination of a plane in a target structure (e.g. subsurface structure) from horizontal. A dip can correspond to a plane wave in the data or a non-horizontal element in the subsurface structure. For example, this non-horizontal subsurface element can be a sedimentary bed, a fault, or other element in the subsurface structure.

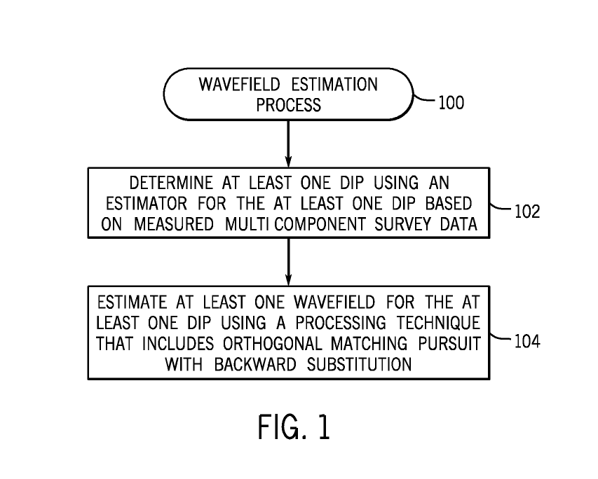

FIG. 1 is a flow diagram of a process 100 for estimating at least one wavefield according to some implementations. The process 100 determines (at 102) at least one dip using an estimator for the at least one dip based on measured multicomponent survey data. Multicomponent survey data is acquired using survey receivers, and can include pressure data and particle motion data. Examples of particle motion data include displacement, velocity, and acceleration. The particle motion data of the multicomponent survey data can include particle motion data in multiple different directions, such as the x, y, and z directions (or other directions). The use of the estimator for the at least one dip is part of multicomponent semblance analysis according to some implementations of the present disclosure. The estimator includes a probability measure for a dip of coherent plane waves within the multicomponent survey data. The coherence of two waves follows from how well correlated the waves are as quantified by a cross-correlation function, where the cross-correlation quantifies the ability to predict the value of a second wave by knowing the content of the first wave.

The process 100 further estimates (at 104) at least one wavefield for the at least one dip using a processing technique that includes orthogonal matching pursuit with backward substitution. The processing technique is a multi-stage technique, in which a first stage includes orthogonal matching pursuit that includes a block orthogonal factorization process, and a second stage that includes backward substitution to perform wavefield construction. Orthogonal matching pursuit is a recursive algorithm for recovering the support of an observed sparse signal (measured survey data), and is discussed further below. Backward substitution is also discussed further below. Although reference is made to orthogonal matching pursuit techniques in some implementations, it is noted that other types of matching pursuit techniques can be employed in further implementations.

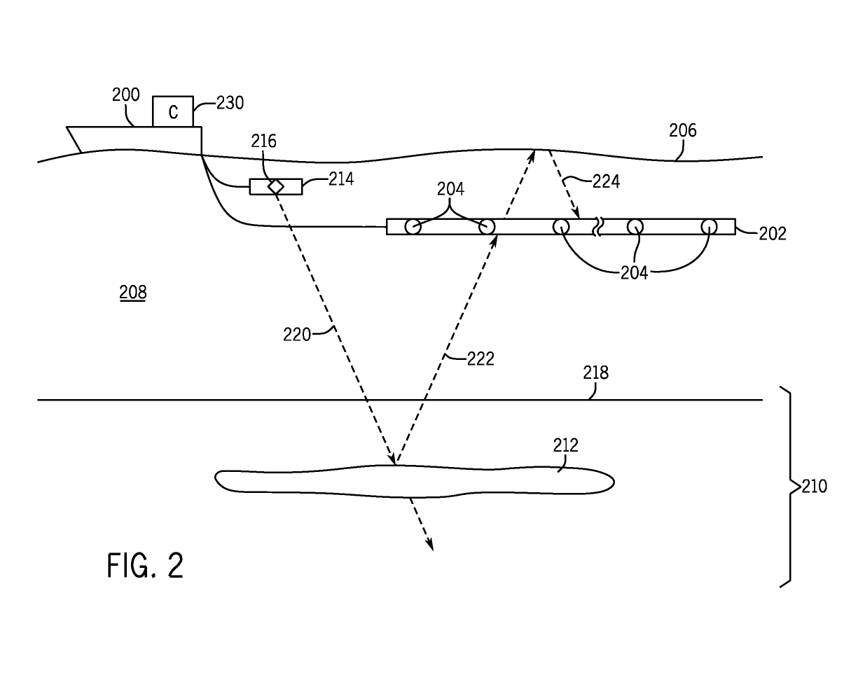

FIG. 2 illustrates an example marine survey arrangement that includes a marine vessel 200 for towing a streamer 202 that includes seismic receivers 204. In addition, the marine vessel 200 (or a different marine vessel) can tow a seismic source assembly 214, which has at least one seismic source 216.

The marine vessel 200 tows the streamer 202 and seismic source assembly 214 through a body of water 208 above a bottom surface 218 (e.g. seafloor). A subsurface structure 210 is located below the bottom surface 218, and the subsurface structure 210 includes at least one subsurface element 212 of interest. Examples of the subsurface element 212 can include a hydrocarbon-bearing reservoir, a freshwater aquifer, a gas injection zone, or other subsurface element of interest.

FIG. 2 further depicts an arrow 220 that represents a seismic wavefield generated by the seismic source 216 and traveling generally downwardly into the subsurface structure 210. A portion of the seismic wavefield 220 is reflected from the subsurface structure 210, and travels generally upwardly (as indicated by arrow 222) toward the streamer 202. The upgoing seismic wavefield (222) is detected by the seismic receivers 204 of the streamer 202.

The upgoing seismic wavefield (222) continues to travel upwardly until the wavefield reaches the air-water interface (206), where the seismic wavefield is reflected generally downwardly (as indicated by arrow 224). The reflected downgoing seismic wavefield (224) is also detected at the seismic receivers 204, which causes ghost data to appear in the measurement data collected by the seismic receivers 204. The reflected downgoing wavefield interacts with the upgoing wavefield, which causes constructive and destructive interference that results in the ghost data. This interference is detrimental to the seismic data since it causes amplitude and phase distortions and can result in total removal of frequencies near the so-called ghost notch frequency.

For simplicity, FIG. 2 depicts an example that includes just one instance of a source downgoing wavefield 220, a reflected upgoing wavefield 222, and a reflected downgoing wavefield 224. In an actual survey environment, there can be many instances of the various downgoing and upgoing wavefields. Also, in other examples, the survey arrangement can include more than one seismic source 216, in which case there can be additional instances of the various wavefields.

FIG. 2 further depicts a control system 230 deployed at the marine vessel 200. The control system 230 can be used to control activation of the seismic source assembly 214. The control system 230 can also receive measurement data collected by the seismic receivers 204. In some examples, the control system 230 is able to process the collected measurement data, such as to develop an image or other representation of the subsurface structure 210. In other examples, the collected measurement data from the seismic receivers 204 can be communicated to a remote system for further processing. The processing performed by the control system 230 or by another system can further include deghosting, crossline interpolation, and so forth, according to some implementations. Deghosting measured survey data refers to removing or mitigating an effect of reflection from the air-water interface 206 (or other type of interface). Crossline interpolation refers to producing interpolated survey data along the crossline direction (direction generally perpendicular to the direction of the streamer 202) at locations where survey receivers do not exist.

FIG. 3 is a top schematic view of another example marine survey arrangement that includes the marine vessel 100, which can tow multiple streamers 302. The streamers 302 include respective collections of survey receivers 304. The survey receivers 304 along a streamer 302 have a relatively fine inter-receiver spacing in the in-line direction (x direction shown in FIG. 3). However, a coarser spacing is provided between the streamers 302 in the crossline direction (y direction in FIG. 3).

The wavefield estimation process discussed above in relation to FIG. 1 can include a localized plane-wave decomposition process applied to multicomponent survey data for use in migration and model building, or for other purposes. Multicomponent semblance is used to estimate dips, and block orthogonal matching pursuit with backward substitution is used for estimation of the wavefields for each estimated dip.

Beam-like migration based on localized plane-wave decomposition of the measured survey data can reduce the cost of imaging and improve model building turnaround time. The localized plane-wave decomposition of multicomponent data is performed in the time-space domain using a block orthogonalized matching pursuit technique in conjunction with a semblance measure used to enforce sparsity in a dip parameter (which represents a dip).

The following considers localized representation of single shot data in terms of plane waves. Single shot data can refer to survey data measured by survey receivers (such as those shown in FIG. 2 or 3) in response to a single activation of at least one survey source., First, the data is partitioned into temporal and spatial windows. Next, a superposition of a plane wave representation of the data is determined For example, assuming that survey receivers are located on a flat surface at depth z, let the windowed measured pressure, P(t, x), as measured by survey receivers at the horizontal location x=[x y]^{T} (x and y are orthogonal to each other in the horizontal plane, and are also orthogonal to z in the vertical direction) at time t be

P(t,x)∫g(t−p·x,p)dp, (Eq. 1)

where g (t, p) represents a wavelet for dip p. The following notation convention is used in the present discussion: bold parameter for elements of [symbol] ³ (three-dimensional space), bold italic parameter for elements of [symbol] ² (two-dimensional space), and italic parameter for elements of [symbol] (one-dimensional space). For example, x∈ [symbol] ³, x, p∈ [symbol] ² and x,y,z∈ [symbol] . For the sake of brevity, for fixed z=z₀x is associated with x, and a function f(x) is supported on the plane z=z₀ by f(x), e.g. V(t, x) and P(t, x) can be denoted as V(t, x) and P(t, x), respectively. V(t, x) represents measured velocity as mesured by survey receivers. In other examples, other particle motion data (e.g. displacement and/or acceleration) can be considered. Starting with Eq. 1 and using the relationship between the gradient of the pressure and temporal change in the velocity,

$$V ( t , x ) = - \frac{1}{ρ ( x )} ▽ P ( t , x ) , \qquad ( Eq . 2 )$$

where ρ(x) represents a density of the subsurface structure, which for the sake of simplicity for purposes of the present discussion can be assumed to be equal to one, and V=[Vₓ V_{y} V_{z}]^{T} represents velocity. At a fixed depth, say z=z₀, the velocity measurements are related to pressure by

V(t,x)=∫p g(t−p·x,p)dp. (Eq. 3)

In Eq. 3, p represents slowness (in multiple directions). Slowness is the inverse of velocity. In practice, according to some examples, a noisy component of V, such as Vₓ, can be ignored by setting the noisy component to zero.

Forward Model with Upgoing and Downgoing Wavelets

Decomposition of the received data into upgoing and downgoing wavefields can be referred to as up-down separation or deghosting. To perform up-down separation, the following convention is assumed. The p (slowness) of the upgoing pressure wave has a positive z-component, p_{z}=\sqrt{1−(pₓ²+p_{y}²)}, and the p (slowness) of the downgoing pressure wave has a negative z-component, −p_{z}=−\sqrt{1−(pₓ²+p_{y}²)}. In the foregoing, pₓ, p_{y}, and p_{z} represent slowness in respective x, y, and z directions. The total pressure and the corresponding velocity are given by

$$[ \begin{matrix}P ( t , x ) \\ V ( t , x )\end{matrix} ] = \int 𝒫 [ \begin{matrix}{g}_{+} ( t - p \cdot x , p ) \\ {g}_{-} ( t - p \cdot x , p )\end{matrix} ] d p , \qquad ( Eq . 4 )$$

where

$$𝒫 = {[ \begin{matrix}1 & {p}_{x} & {p}_{y} & {p}_{z} \\ 1 & {p}_{x} & {p}_{y} & - {p}_{z}\end{matrix} ]}^{T} ,$$

and g₊, g₋ are the upgoing and downgoing wavelets, respectively, that correspond to the dip p.

Eq. 4 above is an example of a forward model that characterizes the pressure and

velocity of a subsurface structure, and

$$𝒫 = {[ \begin{matrix}1 & {p}_{x} & {p}_{y} & {p}_{z} \\ 1 & {p}_{x} & {p}_{y} & - {p}_{z}\end{matrix} ]}^{T}$$

represents the forward model parameters that include slowness in multiple directions.

The forward model of Eq. 4 can be applied to estimate pressure and velocity values of a subsurface structure.

The Inverse Problem with Sparsity Assumption

The inverse problem of deghosting aims to recover the upgoing and downgoing wavelets, g₊(t−p·x,p) and g₋(t−p·x, p), given sampled pressure and velocity measurements P(tₖ, xₘ, yₙ) and V(tₖ, xₘ, yₙ), respectively, for some (tₖ, xₘ, yₙ), where tₖ is a time value, xₘ is an x coordinate value, and yₙ is a y coordinate value. It is assumed that windowed measurements (measured data in spatial windows and time windows) can be composed of a sparse number of plane waves. Data can be considered sparse if the data has zero or negligble values at most locations. Some techniques of the present disclosure aim to find the minimum number M (M>1) of upgoing and downgoing wavelets such that

$$[ \begin{matrix}P ( t , x ) \\ V ( t , x )\end{matrix} ] \approx {\sum }_{m = 1}^{M} 𝒫 [ \begin{matrix}{g}_{+} ( t - {p}_{m} \cdot x , {p}_{m} ) \\ {g}_{-} ( t - {p}_{m} \cdot x , {p}_{m} )\end{matrix} ] . \qquad ( Eq . 5 )$$

at (t, x)=(tₖ, xₘ, yₙ).

Using the diagonal approximation of the normal operators in left and right least square solutions, approximations to Eq. 4 (the forward model) can be obtained by

$$\begin{matrix}\begin{matrix}[ \begin{matrix}{\hat{g}}_{+ . L} ( {t}_{k} , {p}_{x} , {p}_{y} ) \\ {\hat{g}}_{+ , L} ( {t}_{k} , {p}_{x} , {p}_{y} )\end{matrix} ] = \frac{1}{2} {\sum }_{m , n}^{ } \\ [ ( \frac{P ( \begin{matrix}{t}_{k} - {p}_{x} {x}_{m} - \\ {p}_{y} {y}_{n} , {x}_{m} , {y}_{n}\end{matrix} )}{\int d t d {p}_{x} d {p}_{y}} + {p}_{x} \frac{{V}_{x} ( \begin{matrix}{t}_{k} - {p}_{x} {x}_{m} - \\ {p}_{y} {y}_{n} , {x}_{m} , {y}_{n}\end{matrix} )}{\int {p}_{x}^{2} d t d {p}_{x} d {p}_{y}} + {p}_{y} \frac{{V}_{y} ( \begin{matrix}{t}_{k} - {p}_{x} {x}_{m} - \\ {p}_{y} {y}_{n} , {x}_{m} , {y}_{n}\end{matrix} )}{\int {p}_{y}^{2} d t d {p}_{x} d {p}_{y}} + {p}_{z} \frac{{V}_{z} ( \begin{matrix}{t}_{k} - {p}_{x} {x}_{m} - \\ {p}_{y} {y}_{n} , {x}_{m} , {y}_{n}\end{matrix} )}{\int {p}_{z}^{2} d t d {p}_{x} d {p}_{y}} ) ( \frac{P ( \begin{matrix}{t}_{k} - {p}_{x} {x}_{m} - \\ {p}_{y} {y}_{n} , {x}_{m} , {y}_{n}\end{matrix} )}{\int d t d {p}_{x} d {p}_{y}} + {p}_{x} \frac{{V}_{x} ( \begin{matrix}{t}_{k} - {p}_{x} {x}_{m} - \\ {p}_{y} {y}_{n} , {x}_{m} , {y}_{n}\end{matrix} )}{\int {p}_{x}^{2} d t d {p}_{x} d {p}_{y}} + {p}_{y} \frac{{V}_{y} ( \begin{matrix}{t}_{k} - {p}_{x} {x}_{m} - \\ {p}_{y} {y}_{n} , {x}_{m} , {y}_{n}\end{matrix} )}{\int {p}_{y}^{2} d t d {p}_{x} d {p}_{y}} - {p}_{z} \frac{{V}_{z} ( \begin{matrix}{t}_{k} - {p}_{x} {x}_{m} - \\ {p}_{y} {y}_{n} , {x}_{m} , {y}_{n}\end{matrix} )}{\int {p}_{z}^{2} d t d {p}_{x} d {p}_{y}} ) ] & \\ and & \end{matrix} & ( Eq . 6 ) \\ [ \begin{matrix}{\hat{g}}_{+ . R} ( {t}_{k} , {p}_{x} , {p}_{y} ) \\ {\hat{g}}_{+ , R} ( {t}_{k} , {p}_{x} , {p}_{y} )\end{matrix} ] = {\frac{1}{{\sum }_{k , m , n} 1} [ \begin{matrix}2 & 2 {p}_{x}^{2} + 2 {p}_{y}^{2} \\ 2 {p}_{x}^{2} + 2 {p}_{y}^{2} & 2\end{matrix} ]}^{- 1} {\sum }_{m , n}^{ } {P}^{T} [ \begin{matrix}P ( {t}_{k} - {p}_{x} {x}_{m} - {p}_{y} {y}_{n} , {x}_{m} , {y}_{n} ) \\ V ( {t}_{k} - {p}_{x} {x}_{m} - {p}_{y} {y}_{n} , {x}_{m} , {y}_{n} )\end{matrix} ] , & ( Eq . 7 )\end{matrix}$$

respectively. The approximate right least square solution (Eq. 7), which implicitly makes a single dip assumption, is more suitable for utilization in the estimation of the upgoing and downgoing wavelets. The approximate left least square solution (Eq. 6), which implicitly assumes that the data is made up of the dips, is more suitable for estimating the dominant dip components in the data.

Multicomponent Semblance for Dip Estimation

The following describes a multicomponent semblance technique for estimating a dip, in accordance with some implementations.

Using the Cauchy-Schwartz inequality, a bound for the total energy of the upgoing and downgoing wavefields is determined. This bound is used to generalize the standard semblance to multicomponent measurements, and multicomponent semblance (based on Eq. 6) can be defined as

$${S}_{R} ( {p}_{x} , {p}_{y} ) = \frac{{Σ}_{k} {\vert {\hat{g}}_{+ . L} ( {t}_{k} , {p}_{x} , {p}_{y} ) \vert}^{2} + {\vert {\hat{g}}_{- , L} ( {t}_{k} , {p}_{x} , {p}_{y} ) \vert}^{2}}{\begin{matrix}\frac{1}{2} {Σ}_{k} {Σ}_{km , n} [ \frac{{P}^{2} ( \begin{matrix}{t}_{k} - {p}_{x} {x}_{m} - \\ {p}_{y} {y}_{n} , {x}_{m} , {y}_{n}\end{matrix} )}{{[ \int d t d {p}_{x} d {p}_{y} ]}^{2}} + \frac{{p}_{x}^{2} {V}_{x}^{2} ( \begin{matrix}{t}_{k} - {p}_{x} {x}_{m} - \\ {p}_{y} {y}_{n} , {x}_{m} , {y}_{n}\end{matrix} )}{{[ \int {p}_{x}^{2} d t d {p}_{x} d {p}_{y} ]}^{2}} + \\ \frac{{p}_{y}^{2} {V}_{y}^{2} ( \begin{matrix}{t}_{k} - {p}_{x} {x}_{m} - \\ {p}_{y} {y}_{n} , {x}_{m} , {y}_{n}\end{matrix} )}{{[ \int {p}_{y}^{2} d t d {p}_{x} d {p}_{y} ]}^{2}} + \frac{{p}_{z}^{2} {V}_{z}^{2} ( \begin{matrix}{t}_{k} - {p}_{x} {x}_{m} - \\ {p}_{y} {y}_{n} , {x}_{m} , {y}_{n}\end{matrix} )}{{[ \int {p}_{z}^{2} d t d {p}_{x} d {p}_{y} ]}^{2}} ]\end{matrix}} \leq 1. \qquad ( Eq . 8 )$$

In the absence of particle velocity data, i.e. V=0, S_{R} in Eq. 8 reduces to standard semblance for the single component data. By construction, S_{R} is positive, bounded by 1 and constitutes a probability measure, hence an estimator for the dip of coherent plane waves within the multicomponent data. Equality to one holds in the presence of a single plane wave. In the presence of additive noise, S_{R} provides a way to quantify signal to signal-plus-noise ratio. One feature of S_{R} is that during its computation the noise present in each component is compensated accordingly.

In the case of semblance, searching for the dip that extracts a given plane wave converts the semblance measure into a deterministic expectation (simple “line integrals”). In other words, the semblance measure S_{R} is expected to be approximately 1 when it is tuned to the dip direction (pₓ, p_{y}) (also referred to as “dip slope”) corresponding to the dominant plane wave. As discussed above, once pₓ,p_{y} are derived, p_{z} can be derived according to p_{z}=\sqrt{1−(pₓ²+p_{y}²)}.

Orthogonal Matching Pursuit

Orthogonal matching pursuit (OMP) is a recursive algorithm for recovering the support of observed sparse data, and in accordance with some implementations, is used as part of a processing technique for determining a wavefield for a dip. Data representing the subsurface structure can be represented as y∈ [symbol] ^{m}, and the model (operator) can be represented as X∈ [symbol] ^{m×p}, where m<<p. Note that X corresponds to the forward model of Eq. 5.

In some implementations, techniques seek to solve for b∈ [symbol] ^{p} that satisfies y=Xb+n, where n is represents noise. The j-th column of X is denoted as X(j), and the general submatrix of X including columns in some index set [symbol] ⱼ is denoted as X( [symbol] ⱼ). In some examples, the orthgonal matching pursuit algorithm can include the following simplified algorithm to solve for b:
Task 1: Set the iteration counter i=1. Initialize residual rᵢ₋₁=y, index set [symbol] ᵢ₋₁=Φ, and the selected columns of the model as X( [symbol] ᵢ₋₁)=Φ.
Task 2: Calculate cᵢ=argmax_{1≦j≦p}|X(j)^{T}rᵢ₋₁|, and update [symbol] ᵢ= [symbol] ᵢ₋₁∪{cᵢ}.
Task 3: Construct the projection operator Pᵢ=X( [symbol] ᵢ₋₁)[X( [symbol] ᵢ₋₁)^{T}X( [symbol] ᵢ₋₁)]⁻¹X( [symbol] ᵢ₋₁)^{T}. This projects any vector IP onto the subspace spanned by the columns of X( [symbol] ᵢ₋₁). Update the residual rᵢ=(I−Pᵢ)y; this is the projection of the residual onto the orthogonal complement of the subspace spanned by the columns X( [symbol] ᵢ₋₁). The residual rᵢ represents an error (remainder).
Task 4: Check the stopping criteria (e.g. the residual rᵢ less than a threshold, and/or a specified number of iterations has been performed0; if the stopping criteria are not satisfied, increment i and return to Task 2.

Acquired survey data regarding a subsurface structure can include ghost data, as discussed further above. In the case of marine acquisition, suvery receivers below the water surface can register both the upgoing primary energy as well as the reflected, downgoing secondary energy. Techniques according to the present disclosure can separate (deghost) the signal into these upgoing and downgoing components.

To determine a dip direction (pₓ,p_{y}), let A be set with values—ceil(|pₓ|M+|p_{y}|N+K):1:ceil(|pₓ|M+|p_{y}|N+K), where M, N, K∈ [symbol] . Consider any functions wᵤ:A→ [symbol] and w_{d}: A→ [symbol] ; these represent discrete samples of arbitrary wavelets. Using standard sinc interpolation (Whittaker-Shannon interpolation formula), the values of the wavefield can be computed at times Tₖₘₙ=tₖ−pₓxₘ−p_{y}yₙ with k≦K, m≦M, n≦N. In other words, the wavelets are propagated in time across the spatial grid.

Algorithm

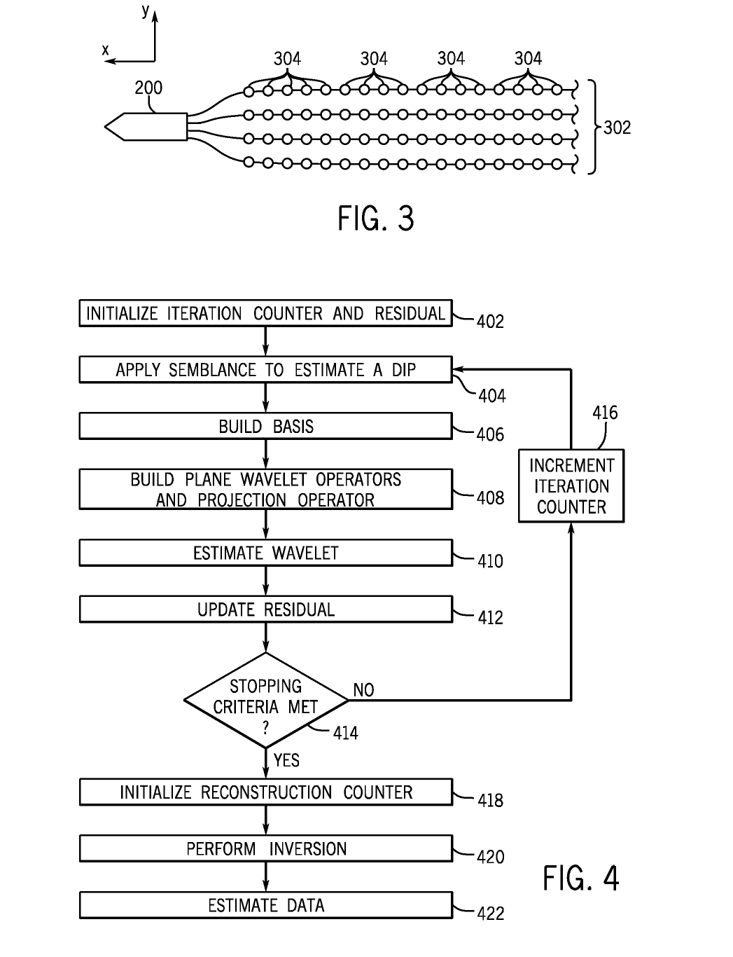

The semblance measure S_{R} (Eq. 8) introduced above allows for the isolation of the highest energy (and coherency) “components” (in terms of the dip slope (pₓp_{y})) for general multicomponent seismic data. The idea behind the algorithm according to some implementations of the present disclosure is to iteratively identify the dominant plane wave component in the observed data (pressure+velocity) that includes maximizing the semblance and to remove this dominant plane wave component using the orthogonal matching pursuit process discussed above. The following refers to FIG. 4, which depicts various tasks of the algorithm according to some implementations (reference numerals in FIG. 4 are identified below).
402: Initialize. Set the iteration counter i=1. Define the initial residual to be the observed data: rᵢ₋₁=(P, Vₓ, V_{y}, V_{z})^{T}∈ [symbol] ^{4KMN}.
404: Apply semblance. As discussed above in connection with Eq. 8, multicomponent semblance can be used to estimate a dip, which includes determining a dip slope (p_{x′}, p_{y′}) that maximizes multicomponent semblance S_{R}(pₓ, p_{y}), as defined by Eq. 8, for residual rᵢ₋₁. This is analogous to task 2 of the simplified orthgonal matching pursuit algorithm above.
406, 408: Build plane wavelet operators. For the picked dip slope determined at task 404, the plane wavelet basis is constructed (406) on a target grid using standard sinc interpolation. The construction of the plane wavelet basis gives (P_{I}, vₓ_{_{I}}, v_{y}_{_{I}}, v_{z}_{_{I}})^{T}∈ [symbol] ^{4MNK×W}. To deghost the seismic signal into upgoing and downgoing components, the algorithm assembles (408) the operator

$${X}_{i - 1} = {( \begin{matrix}{P}_{I} & {V}_{{x}_{I}} & {V}_{{y}_{I}} & {V}_{{z}_{I}} \\ {P}_{I} & {V}_{{x}_{I}} & {V}_{{y}_{I}} & - {V}_{{z}_{I}}\end{matrix} )}^{T} ∈ {ℝ}^{4 MNK \times 2 W} \qquad ( Eq . 9 )$$

and its normal operator Sᵢ₋₁=Xᵢ₋₁^{T}Xᵢ₋₁∈ [symbol] ^{2W×W}. Note that Xᵢ₋₁ corresponds to the forward model X discussed above in connection with the simplified orthogonal matching pursuit algorithm, and Eq. 9 is a version of Eq. 4. In task 408, Bᵤₚ represents an upgoing wavefield, and B_{down} represents a downgoing wavefield.
408: Build projection operator. For a natural number 1≦j≦i−1, the algorithm also forms (408) the orthogonal projection operator

Oⱼ=Oⱼ₋₁−Xⱼ₋₁Sⱼ₋₁⁻¹Xⱼ₋₁^{T} (Eq. 10)
which allows for the construction of the projected plane wave operator

Aᵢ₋₁=Oᵢ₋₁Xᵢ₋₁ (Eq. 11)
Forming the orthogonal projection operator is analogous to task 3 of the simplified orthgonal matching pursuit algorithm discussed above. The projection operator assumes that there is just one dip in the subsurface structure being considered. Thus, any previously estimated dips are removed from the current estimated data.
410: Estimate wavelet. Wavelets wᵢ₋₁ are estimated by solving for Aᵢ₋₁ according to Eq. 11.
412: Update residual. After solving Aᵢ₋₁wᵢ₋₁=rᵢ₋₁, the residual is updated by setting rᵢ=rᵢ₋ᵢ−Aᵢ₋₁wᵢ₋₁.
414: Check stopping criteria. If the stopping criteria is met (e.g. the maximum number of plane wave components is determined, a residual norm is less than a specified threshold, and so forth), the algorithm proceeds to task 418; else the counter i is incremented by 1 (416) and the algorithm returns to task 404 to perform the next iteration of the orthogonal matching pursuit algorithm that includes tasks 406-412.
418: Initialization #2. Task 418 is performed in response to the stopping critiria being met, as determined by task 414. The algorithm initializes a reconstruction counter k=i, where i is the final iteration count from task 414. The initialization also sets bₖ=r₀−Xₖwₖ. At this point, the estimated wavelets wₖ may not be accurate in view of the assumption that there is a single plane wave (corresponding to the assumption of a single dip). Task 420 below is performed to update the estimated wavelets such that more accurate wavelets w′ₖ are derived to account for presence of multiple dips in the subsurface structure. The updated wavelets w′ₖ correspond to respective dips in the subsurface structure.
420: Perform inversion. Set cₖ=Oₖ₋₁bₖ and solve Aₖ₋₁w′ₖ=cₖ and update bₖ₋₁=bₖ−Xₖ₋₁w′ₖ. Decrement k by 1 and re-iterate task 420 until k=1.
422: Once the reconstruction counter has decremented to 1 (k=1), the recovered data is represented by dₑₛₜ=Σⱼ₌₁ⁱ Xⱼw′ⱼ. The data dₑₛₜ is the final estimate of the pressure and velocity data. Note that tasks 418 and 420 are part of the backwards substitution technique discussed above.

Assume that both upgoing and downgoing wavelets can be represented using an interpolation scheme g_{±}(t, p)=ΣₗI(t,l)g_{±,l}(p), where I is the interpolation kernel. For example, for bandlimited functions with bandwidth B, I(t,l)=sinc(B(t−tₗ)) is a suitable interpolation kernel. The algorithm can use a block orthogonal matching pursuit technique where each block is determined by time samples l and dip pₘ. The algorithm is composed of two tasks: a block orthogonal factorization (“QR”) task and wavelet construction (“Backward substitution”) task. The resulting approximation is equivalent to constructing the least squares approximation to the data in the interpolation basis that is sparse in the dip pₘ.

In some implementations, a technique for constructing a parsimonious plane wave representation of multicomponent seismic data is provided for use in beam migration. Approaches according to some implementations utilize a generalized multicomponent semblance to overcome aliasing in the crossline direction and improve automatic picking of coherent linear events. Wavelet estimation and deghosting is done in a block orthogonal matching pursuit framework that complements the iterative picking of the slope parameters. The block OMP algorithm is designed to incorporate noise filtering on individual picked events in the wavelet estimation, to allow for separation of upgoing and downgoing wavefields, and the robust and accurate picking of dip parameters in the presence of aliasing.

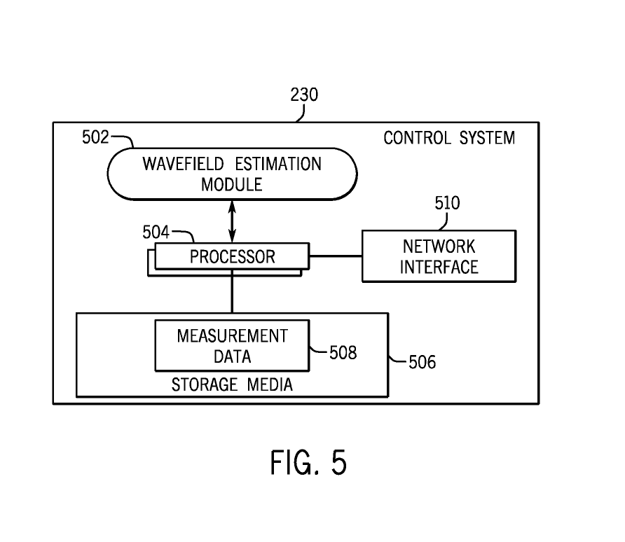

FIG. 5 illustrates an example control system 230 according to some implementations. The control system 230 includes a wavefield estimation module 502 for performing a wavefield estimation process, such as according to FIG. 1 or 4. The wavefield estimation module 502 can be implemented as machine-readable instructions executable on one or multiple processors 504. The control system 230 can be implemented with a computer system, or with a distributed arrangement of computer systems. A processor can include a microprocessor, a microcontroller, a physical processor module or subsystem, a programmable integrated circuit, a programmable gate array, or another physical control or computing device.

The processor(s) 504 is (are) connected to a storage medium (or storage media) 506, which can store measurement data 508 collected by the survey receivers 204 or 304 depicted in FIG. 2 or 3. The control system 230 also includes a network interface 510 to allow the control system 230 to communicate with another system, such as with the streamer 202 or 302 to collect the measurement data, or with another system that communicates the measurement data to the control system 230.

The storage medium (or storage media) 506 can be implemented as one or more non-transitory computer-readable or machine-readable storage media. The storage media can include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In general, according to some implementations, at least one dip is determined using an estimator for the at least one dip based on measured multicomponent survey data. At least one wavefield for the at least one dip is estimated using a processing technique that employs matching pursuit.

In general, according to further or other implementations, the matching pursuit comprises orthogonal matching pursuit.

In general, according to further or other implementations, semblance analysis is used to determine a slope of the dip.

In general, according to further or other implementations, the measured multicomponent survey data includes pressure data and particle motion data measured by survey receivers.

In general, according to further or other implementations, estimating the at least one wavefield comprises estimating an upgoing wavefield and a downgoing wavefield.

In general, according to further or other implementations, deghosting of the measured multicomponent survey data is performed using the estimated downgoing wavefield.

In general, according to further or other implementations, at least one of an image of a target structure and a model of the target structure are determined using the estimated at least one wavefield.

In general, according to further or other implementations, the processing technique further includes backward substitution performed after the orthogonal matching pursuit, the backward substitution to construct the at least one wavefield.

In general, according to further or other implementations, using the estimator is part of a semblance analysis based on the measured multicomponent survey data, the semblance analysis identifying a slope of the dip that increases multicomponent semblance for a residual.

In general, according to further or other implementations, a plane wavefield basis for the slope of the dip is constructed.

In general, according to further or other implementations, at least one plane wavefield operator is built using the plane wavefield basis, and the at least one wavefield is estimated using the at least one plane wavefield operator.

In general, according to further or other implementations, the at least one plane wavefield operator includes plane wavefield operators to construct upgoing and downgoing wavefields.

In general, according to further or other implementations, using the estimator is part of a semblance analysis based on the measured multicomponent survey data, the semblance analysis to identify a plane wave component in the multicomponent survey data.

In general, according to further or other implementations, the orthogonal matching pursuit is used to remove the plane wave component.

In general, according to further or other implementations, the dip is part of a plane wave component of a subsurface structure.

In general, according to further or other implementations, the measured multicomponent survey data is acquired using survey receivers.

In general, according to further or other implementations, a computer system comprises at least one processor configured to perform any of the foregoing tasks.

In general, according to further or other implementations, an article comprises at least one non-transitory machine-readable storage medium storing instructions that upon execution cause a system to perform any of the foregoing tasks.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
determining, by a system including a processor, at least one dip using an estimator for the at least one dip based on measured multicomponent survey data; and
estimating, by the system, at least one wavefield for the at least one dip using a processing technique that employs matching pursuit.

2. The method of claim 1, wherein the matching pursuit comprises orthogonal matching pursuit.

3. The method of claim 1, further comprising using semblance analysis to determine a slope of the dip.

4. The method of claim 1, wherein the measured multicomponent survey data includes pressure data and particle motion data measured by survey receivers.

5. The method of claim 1, wherein estimating the at least one wavefield comprises estimating an upgoing wavefield and a downgoing wavefield.

6. The method of claim 5, further comprising performing deghosting of the measured multicomponent survey data using the estimated downgoing wavefield.

7. The method of claim 1, further comprising determining at least one of an image of a target structure and a model of the target structure using the estimated at least one wavefield.

8. The method of claim 1, wherein the processing technique further includes backward substitution performed after the matching pursuit, the backward substitution to construct the at least one wavefield.

9. The method of claim 1, wherein using the estimator is part of a semblance analysis based on the measured multicomponent survey data, the semblance analysis identifying a slope of the dip that increases multicomponent semblance for a residual.

10. The method of claim 9, further comprising:
constructing a plane wavefield basis for the slope of the dip; and
building at least one plane wavefield operator using the plane wavefield basis,
wherein the at least one wavefield is estimated using the at least one plane wavefield operator.

11. The method of claim 10, wherein the at least one plane wavefield operator includes plane wavefield operators to construct upgoing and downgoing wavefields.

12. The method of claim 1, wherein using the estimator is part of a semblance analysis based on the measured multicomponent survey data, the semblance analysis to identify a plane wave component in the multicomponent survey data.

13. The method of claim 12, further comprising using the matching pursuit to remove the plane wave component.

14. The method of claim 1, wherein the dip is part of a plane wave component of a subsurface structure.

15. A system comprising:
at least one processor to:
perform semblance analysis to estimate a dip in a target structure based on measured multicomponent survey data from survey receivers;
estimate a wavefield for the dip using a processing technique that employs matching pursuit.

16. The system of claim 15, wherein the estimating of the wavefield uses a computation that assumes a single dip in the target structure.

17. The system of claim 16, wherein the at least one processor is to further update the estimated wavefield to account for multiple dips in the target structure.

18. The system of claim 16, wherein the estimating comprises estimating an upgoing wavefield and a downgoing wavefield.

19. An article comprising at least one non-transitory machine-readable storage medium storing instructions that upon execution cause a system to:
determine at least one dip using an estimator for the at least one dip in a target structure based on measured multicomponent survey data; and
estimate at least one wavefield for the at least one dip using a processing technique that employs orthogonal matching pursuit.

20. The article of claim 19, wherein the processing technique further includes backward substitution performed after the orthogonal matching pursuit, the backward substitution to update the at least one wavefield to account for presence of multiple dips in the target structure.
